(19) United States
(12) Patent Application Publication
(10) Pub. No.: US 2017/0178162 A1
(43) Pub. Date: Jun. 22, 2017

(54) Control of which Sources are used to Answer Questions in a Digital Medium Environment

(71) Applicant: Adobe Systems Incorporated, San Jose, CA (US)

(72) Inventors: Ashish Duggal, Delhi (IN); Sachin Soni, New Delhi (IN); Anmol Dhawan, Ghaziabad (IN); Stéphane D. Moreau, L'HAY LES ROSES (FR)

(21) Appl. No.: 14/978,450

(22) Filed: Dec. 22, 2015

(51) Int. Cl. G06Q 30/02; H04L 29/08

(52) U.S. Cl. CPC G06Q 30/0203; H04L 67/12; H04L 67/02

(57) ABSTRACT

A digital medium environment is described to control which source is used to generate an answer to a question about products or services made available via a service provider. Identification is performed as to which products or services of a service provider correspond to text of a question. A determination is then made as to which of a plurality of feature areas of the identified products or services correspond to the text of the question. Data is queried that describes interaction of users with respective ones of the products or services made available via the service provider. The querying is based at least in part on the determined feature areas for the identified products or services to select at least one of the users to receive a request to generate the answer to the question.

### BACKGROUND

Question answering techniques are used to support a variety of functionality in a digital medium environment, such as to form recommendations, reviews, and so forth. For example, a user may interact with a service provider that provides digital content for consumption by users, such as movies, books, and so forth. The user may have a question regarding a particular item of digital content, e.g., a movie, and post that question to the service provider in the hopes of achieving an answer that not only pertains to the question, but also accurately provides a desired answer. For example, a question posted to a comments section of the movie is typically able to be answered by any user that interacts with the service provider, and thus may be answered by users regardless of whether the user has interacted with that item of digital content. Thus, these answers may be inaccurate and even completely irrelevant to the question.

To address this, conventional techniques have been developed to restrict sources answers to the questions to owners of the product. However, these conventional techniques may also lack accuracy and thus lead to user frustration and missed opportunities to sell a product or service by the service provider. For example, a service provider may implement functionality to support a questions and answers section that enables users to ask questions about a product and have the question answered by an owner of the product. For example, assume a shopper wants to buy a new smartphone, and has the following question to ask “I have heard that camera app of the smartphone is pretty slow and often starts with a lag”. Once this question is asked, a conventional online shopping platform may randomly select existing owners of the smartphone, and ask the existing owners to answer the question.

Once a question is successfully answered by an owner, it becomes part of answered questions database for that product. Future shoppers on the online shopping platform can browse these answered questions to get quick answers for their queries. However, by randomly selecting existing owners to answer questions about products, conventional systems fail to identify and ask owners that are most likely to provide a correct or comprehensive answer to the question. Additionally, even when a question is satisfactorily answered, the question itself often includes a negative sentiment which may negatively influence a shopper's decision to buy the product even if the answers to the question are positive.

The problem is further exacerbated when a product or service is newly released. For example, data used by conventional question and answer techniques may be sparsely populated until users begin asking questions about the product or service. The absence of questions and answers may therefore cause some shoppers to be hesitant about whether to buy a new product or service when newly released, which is also frustrating to users and results in missed opportunities on the part of the service provider.

### SUMMARY

A digital medium environment is described to control which source is used to generate an answer to a question about products or services made available via a service provider. The control increases a likelihood of generation of an accurate answer to the question. First, text of the question is received, such as communicated from an originator to a service provider via a network. Identification is performed as to which of the products or services of the service provider correspond to text of a question.

A determination is then made as to which of a plurality of feature areas of the identified products or services correspond to the text of the question. Data is queried that describes interaction of users with respective ones of the products or services made available via the service provider. The querying is based at least in part on the determined said feature areas for the identified products or services to select at least one of the users to receive a request to generate the answer to the question. A communication is then formed that includes the question for receipt by the selected user via a network as the request to act as the source for the answer.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different instances in the description and the figures indicate similar or identical items.

FIG. 1 illustrates an environment in an example implementation that is operable to employ techniques described herein.

FIG. 2 illustrates a system in an example implementation in which feature areas of a product offered for sale on a shopping platform are identified.

FIG. 3 illustrates an example of a product page of a shopping platform.

FIG. 4 illustrates a system in an example implementation in which features scores are generated.

FIG. 5 illustrates a system in an example implementation in which feature experts are identified to answer a question about a product.

FIG. 6 illustrates an additional example of the product page of the shopping platform.

FIG. 7 illustrates a system in an example implementation in which feature experts are contacted to answer a question.

FIG. 8 illustrates an example communication communicated to a feature expert.

FIG. 9 illustrates an example communication that may be communicated to a user to determine whether an answer is helpful.

FIG. 10 illustrates an example communication that may be communicated to a user to modify the sentiment of an answer.

FIG. 11 illustrates an additional example of the product page of the shopping platform.

FIG. 12 illustrates a procedure in an example implementation of generating features scores for users.

FIG. 13 depicts a procedure in an example implementation of a digital medium environment to control which of a plurality of sources is used to generate an answer to a question about products or services made available via a service provider, the control based on features scores used to identify which of the plurality of sources correspond to the question.

FIG. 14 illustrates a procedure in an example implementation of causing display of a question and an answer in a user interface.

FIG. 15 illustrates a procedure in an example implementation of preemptively asking feature experts questions about a new product.

FIG. 16 illustrates an example system that includes an example computing device that is representative of one or more computing systems and/or devices that may implement the various techniques described herein.

### DETAILED DESCRIPTION

Overview

Conventional question answering techniques typically lack accuracy due to lack of control of a source, from which, an answer to the question is obtained. In one example, unfettered access of other users to answer questions may obtain answers regarding a product or service from users that have no experience or interaction with the product or service. In another example, random selection of users that have been identified as having interacted with the product or service may also result in answers that lack accuracy, such as due to a lack of experience by the user with particular features of the product or service.

Accordingly, techniques are described to control which source is used to generate an answer to a question in a digital medium environment, and thus improve a likelihood that the answer is accurate as viewed by an originator of the question. Thus, rather than randomly selecting owners to answer a question about a product as performed in conventional techniques, the described techniques automatically and without user intervention identify users that are determined to have an increased likelihood of generating an accurate answer to a question about a product or service based on determining a level of expertise of the users with the product or service itself, as well as feature areas of the product or service that is referenced in the question.

As described herein, “products” may include any type of product, good, or service that can be purchased from a shopping platform, such as electronic devices, clothing, vitamins, toys, art, cars, and so forth. Each product may include various different feature areas, which correspond to important features of the product. For example, for a smartphone, feature areas may include the display, screen size, battery life, camera, design, and so forth. As another example, for a car, feature areas may include gas mileage, sound system, design, safety rating, and so forth. “Services” includes services that are made available directly from a service provider (e.g., to stream a movie or other digital content) or indirectly from the service provider, e.g., purchased from the service provider and then provided by another source.

In one or more implementations, “feature areas” of products or services that are made available by the service provider may be automatically identified by analyzing textual descriptions of the product or service presented on webpages of the service provider. For example, the service provider may include a product page for a particular product that includes the name of the product, the price, a control to purchase the product, and a textual description of the product. A text analysis module can be implemented to analyze the textual description of the product to identify keywords in the textual description which may correspond to the feature areas as further described below.

For each identified feature area, feature-specific communities of users that have interacted with content regarding the feature area are automatically generated. The feature specific communities include users that are considered “feature experts” that have a high level of expertise regarding a particular product or service feature, such as an owner of a product. For example, in the case of a smartphone, feature experts may be identified for each of the display of the smartphone, the camera of the smartphone, and so forth. Other examples of feature experts include users that have not owned the product but have interacted with the product and thus although ownership is described in the following is should be readily apparent that this is but one example of a source that is usable to generate an answer to a question.

The feature experts may be determined based on content that is consumed (e.g., reading about the product or service) or provided (e.g., writing a user review about the product or service) by users while interacting with the service provider. To do so, user interaction with the service provider or other service providers is monitored, e.g., through analytics that collects data from a variety of service providers. Content that is consumed or provided by the user is analyzed by a text analysis module to determine feature areas of the product or service that are included in the content. A feature score is generated, based on the content consumed or provided by the user, which reflects the level of expertise of the user regarding the particular feature area. For example, a user that reads extensively about the camera of a smartphone or writes a review about the camera of the smartphone causes generation of a feature score indicating this interaction with this feature area. The feature score is then associated with a user profile of the user in a database that is searchable or filterable by the feature score to locate which users are most likely to generate an accurate answer to a question based on these scores.

Once sources that have a likelihood of generating an accurate answer to a question are selected, communications are formed for communication to these sources via a network. Answers are then obtained, which are provided to an originator of the question. In one or more implementations, functionality is provided to enable a user to indicate that the answer is accurate. If done so, this functionality permits the question and answer to be exposed to other users accessing the service provider via the network. In this way, a likelihood is increased that accurate answers to questions are exposed by the service provider, which may be leveraged for consumption by multiple users. This conserves resources in the generation of answer and availability to multiple answers to questions, thereby promoting efficient user interaction and likely conversion of products or services by the service provider. Further discussion of these and other features is included in the following sections.

Example Environment

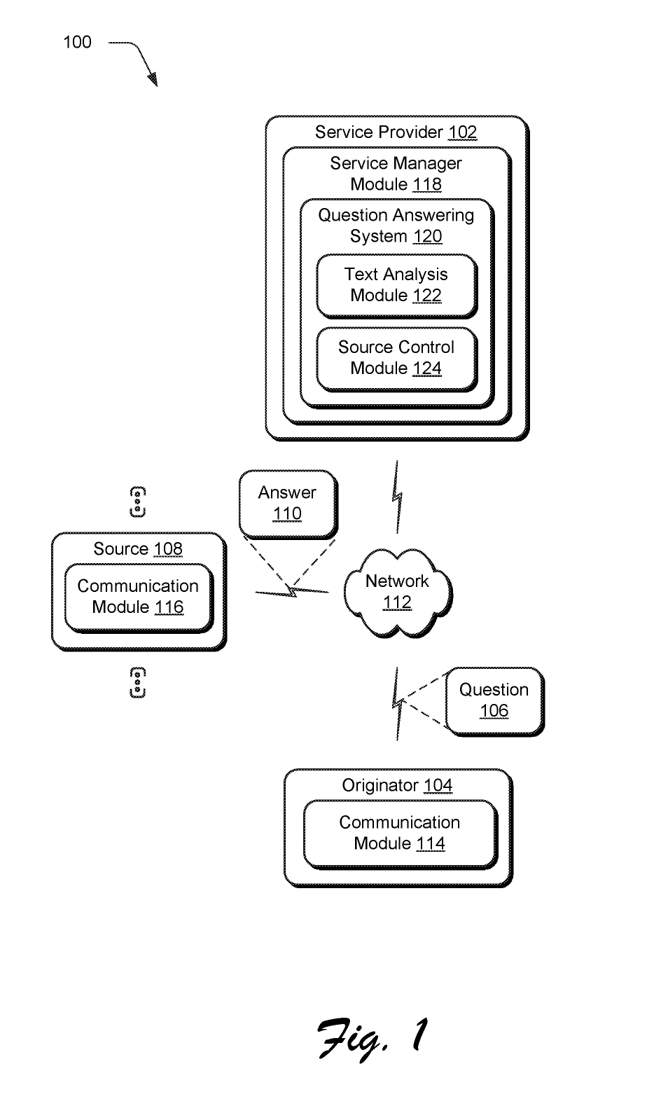

FIG. 1 is an illustration of a digital medium environment 100 in an example implementation that is operable to employ techniques described herein. The digital medium environment 100 includes a service provider 102 that is configured to make a plurality of goods or services available, an originator 104 of a question 106, and a plurality of sources 108 that are available to generate an answer 110 to the question 106 that are communicatively coupled, one to another, via a network 112. Computing devices that implement the service provider 102, originator 104, and source 108 may be configured in a variety of ways.

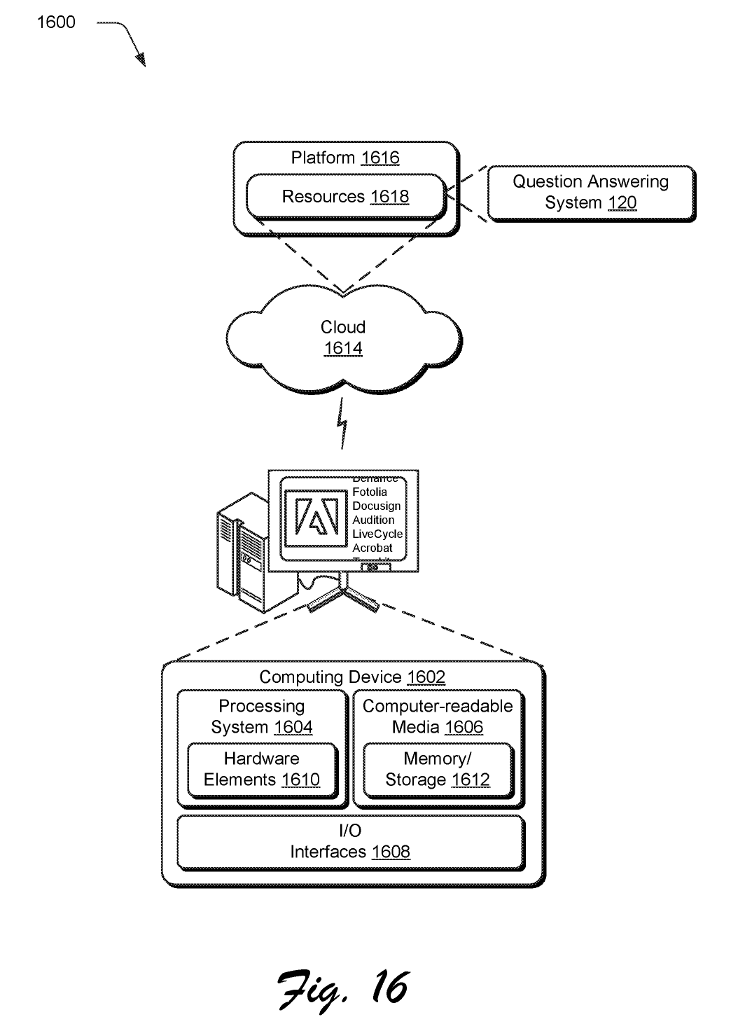

A computing device, for instance, may be configured as a desktop computer, a laptop computer, a mobile device (e.g., assuming a handheld configuration such as a tablet or mobile phone), and so forth. Thus, a computing device may range from full resource devices with substantial memory and processor resources (e.g., personal computers, game consoles) to a low-resource device with limited memory and/or processing resources (e.g., mobile devices). Additionally, although a single computing device is described in some instances, the computing device may be representative of a plurality of different devices, such as multiple servers utilized by a business to perform operations “over the cloud” for the service provider 102, further discussion of which may be found in relation to FIG. 16.

The originator 104 and source 108 are each illustrated as having respective communication modules 114, 116 that are configured to access the service provider 102 via the network 112, e.g., as web browsers, network enabled applications, and so forth and thus communication between the service provider 102, originator 104, and source 108 is accomplished via computing devices and access to the network 112 in this digital medium environment for a user of the originator 104 of the question 106 as well as users of the source 108 to answer 110 the question 106.

Although network 112 is illustrated as the Internet, the network may assume a wide variety of configurations. For example, network 112 may include a wide area network (WAN), a local area network (LAN), a wireless network, a public telephone network, an intranet, and so on. Further, although a single network 112 is shown, network 106 may also be configured to include multiple networks.

The service provider 102 is illustrated as including a service manager module 118 that is representative of functionality to control provision of services (e.g., web services) that are made available via the network and associated functionality. For example, the services may include a digital shopping platform that may be implemented as a website or digital store that is configured to enable users to purchase products or services. In one example, the digital shopping platform is associated with a business that manufactures and sells its own products or services. Alternately, the digital shopping platform may be associated with a business that sells products or services made available via a variety of different service providers and manufacturers. As previously described, although an example involving a digital shopping platform is described in the following, other examples of use of the source control techniques described herein are also contemplated, e.g., as part of a recommendation system, product or service rating service, knowledge collection platform, and so forth.

The service manager module 118 is further illustrated as including a question answering system 120. The question answering system is representative of functionality to manage questions 106 and answers 110 in the digital medium environment 110. As part of this, the question answering system 120 includes a text analysis module 122 and a source control module 124

For example, the question answering system 120 may employ functionality to identify which of the plurality of sources 108 are most likely to generate an accurate answer 110 to the question 106, which are also referred to as “feature experts” in the following. As described herein, feature experts correspond to users with a high level of expertise regarding a particular feature area of a product or service made available via the service provider 102. Thus, feature experts may include owners of product with a high level of expertise regarding a feature area of a product, e.g., a camera of a mobile phone. Also, a user can become a feature expert without being an owner of product or having directly interacted with a service. For example, a journalist or blogger who writes about technology products may be considered a feature expert about features of a product that he has researched and written about and/or interaction with services has been observed.

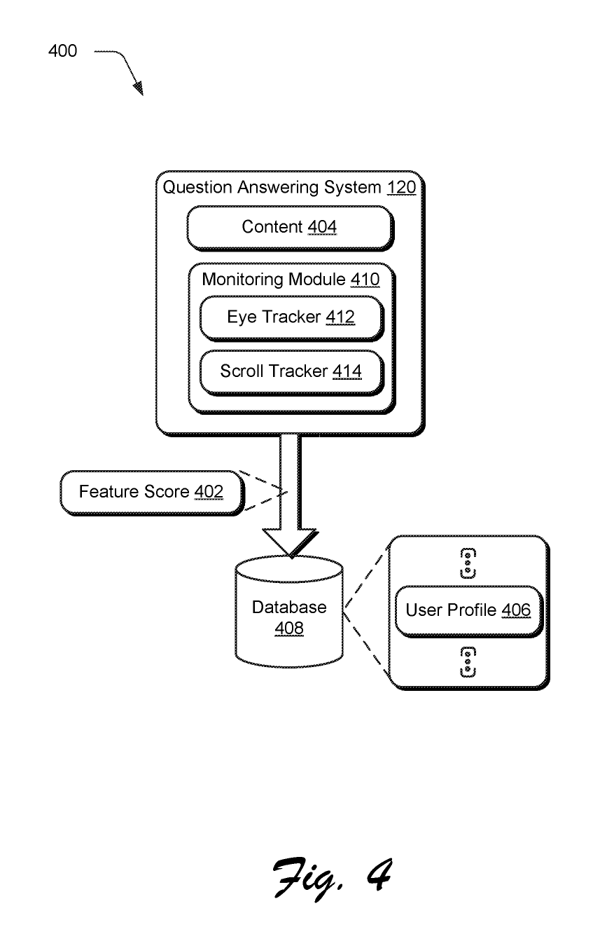

In order to identify which of the sources 108 are to be used as feature experts to generate the answer 110, the question answering system 120 includes a text analysis module 122 and a source control module 124. The text analysis module 122 generates features scores and associates each feature score with a user profile of a user in a database as further described in relation to FIG. 4. Subsequently, question answering system 120 may identify feature experts as users that have a high feature score 402 (e.g., above a particular threshold) corresponding to features mentioned in a particular question.

Text analysis module 122 is representative of functionality to analyze the text to identify feature areas of a product or service, with which, individuals ones of the sources 108 have interacted. For example, the text analysis module 112 may determine which words are mentioned in a product description that likely correspond to a feature area of a product or service. One of the sources 108, for instance, may have interacted with webpages of the service provider 102 regarding camera settings of a camera of a mobile phone. Through use of the text analysis module 112 monitored interaction of a source with those webpages, comments regarding camera settings, and so forth may be used to generate a feature score indicating that that source is to be considered a “feature expert” for that feature area of the product or service. The text analysis module 122 may be implemented as any type of natural language processing (NLP) engine that is configured to perform part of speech tagging to generate keywords, such as natural language toolkit (NLTK), Adobe® Sedona 3, Semantria Engine, and so forth. Text analysis module 122 may also employ a keyword frequency module and a sentiment engine, as will be discussed in more detail below.

Further discussion of the functionality of question answering system 120 can be found below. Although illustrated as part of service provider 102, functionality represented by question answering system 120 and included text analysis module 122 and source control 124 may be further divided, e.g., as part of a third-party service provider, further discussion of which may be found in relation to FIG. 16.

Identifying Feature Areas of a Product

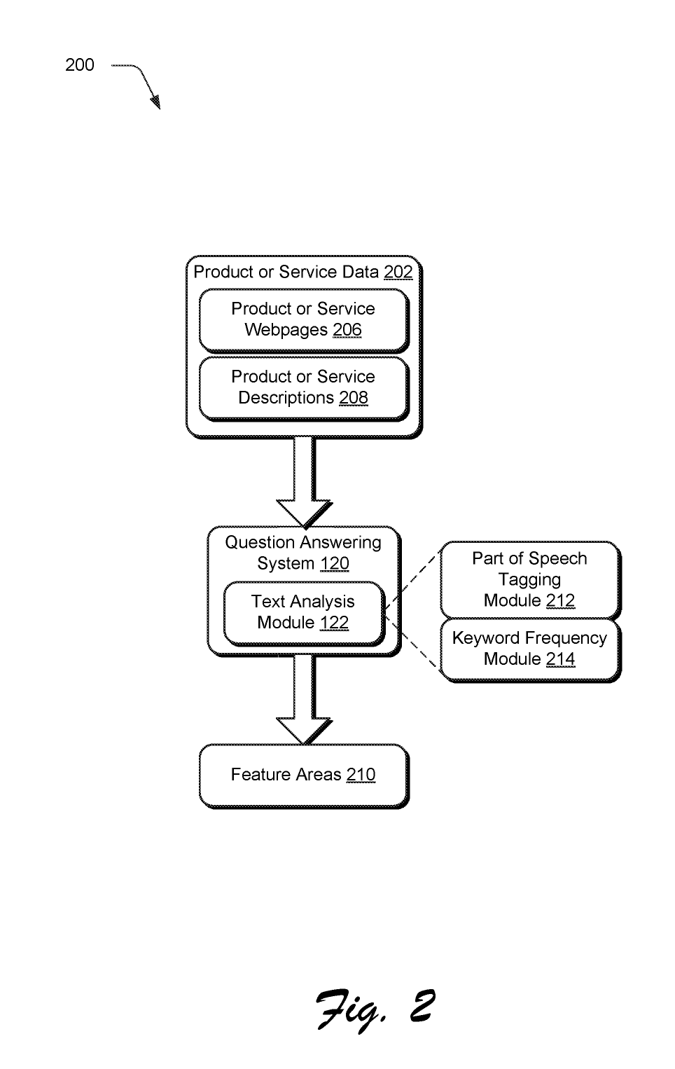

FIG. 2 illustrates a system 200 in an example implementation in which operation of the text analysis module 122 of FIG. 1 is shown in greater detail as identifying feature areas of products or services provided by the service provider 102 of FIG. 1. The question answering system 120 receives product or service data 202 that references content available from the service provider 102 that describes products or services made available via the service provider 102, illustrated examples of which include product or service webpages 206 and product or service descriptions 208. Product or service descriptions 208 may include any type of textual description of a product or service, e.g., that is included on product or service webpages 206, such as technical descriptions, user reviews, answers, and so forth.

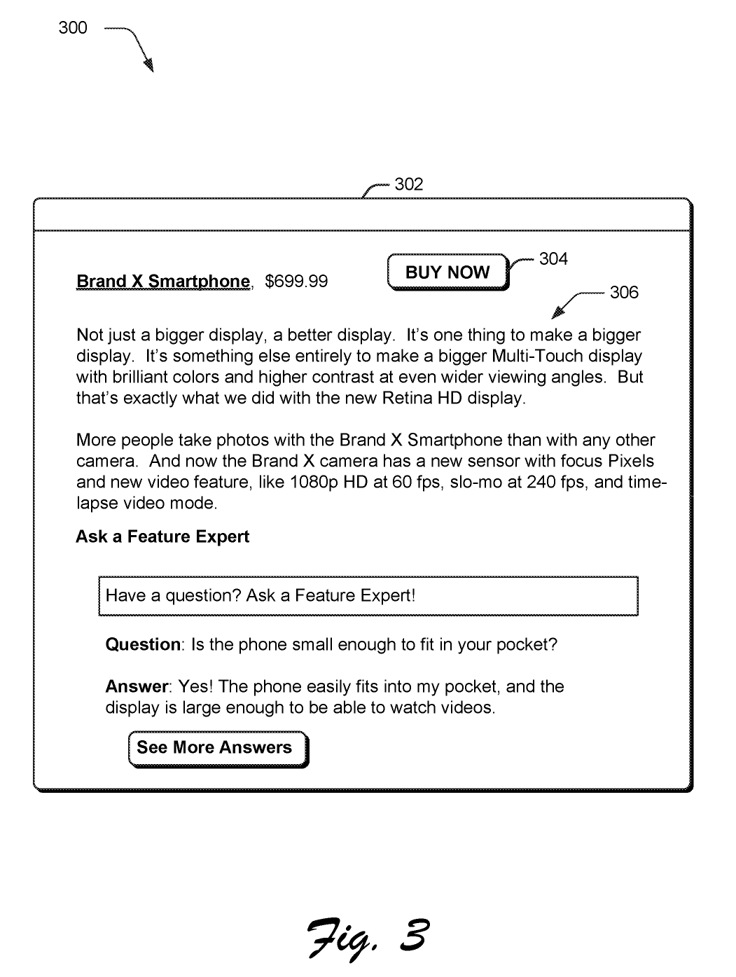

As an example, consider FIG. 3 which illustrates an example of a product page 300 of a shopping platform of the service provider 102. In this example, a product page, corresponding to a product named “Brand X Smartphone”, is displayed in a user interface 302. Product page 300 lists the price of the Brand X Smartphone ($699.99), and includes a buy now control 304, which can be selected to purchase the Brand X Smartphone. Product page 300 also includes a product description 306 of the Brand X Smartphone which describes various features of the Brand X Smartphone.

The text analysis module 122 in this example is implemented to analyze the collected text of product descriptions 306 or service and identify feature areas 210. For example, for the product description 306 of Brand X Smartphone described in FIG. 3, text analysis module 122 may identify keywords corresponding to feature areas 210 such as “display” and “camera”, since these words occur in the text of the product description.

In one or more implementations, to identify feature areas 210, text analysis module 122 implements a part of speech (POS) tagging module 212 that is configured to classify words in product or service descriptions into corresponding parts of speech. After part of speech tagging module 212 performs the POS tagging, text analysis module 122 can identify whether a word is a noun, proper noun, verb, adjective, pronoun, article, and so forth. Notably, nouns and proper nouns are of interest to text analysis module 122 because nouns often correspond to feature areas 210, such as battery, design, display, screen, and so forth. Thus, the nouns and proper nouns enable text analysis module 122 to identify each of the feature areas 210 discussed in product and service descriptions.

Then, in order to determine feature areas 210, text analysis module 122 implements a keyword frequency module 214 that is representative of functionality to determine the frequency of the nouns and proper nouns mentioned in the text of the descriptions. The feature areas 210 can then be determined as the words that occur in descriptions with a high frequency. In some cases, a marketer or business owner or other entity may supplement this data by providing a list of one or more feature areas 210 associated with a product or service manually.

Generating Feature Scores

FIG. 4 depicts a system 400 in an example implementation in which feature scores 402 are generated that are used as a basis to select sources 108 by the question answering system 120. For each identified feature area 210 of FIG. 2, the question answering system 120 is configured to generate feature-specific communities of feature experts. The feature-specific communities include feature experts who are calculated to have a relatively high level of expertise regarding a particular feature areas 210. To do so, a feature score 402 is generated, based on content 404 describing a user's interaction with features areas of the products or services, which reflects a level of expertise of the user regarding the particular feature area. The feature score 402 can then be associated with a user profile 406 in a database 408 that is searchable and/or filterable by the feature score.

As illustrated in system 400, the question answering system 120 includes a monitoring module 410 that is representative of functionality to monitor interactions of users (e.g., the sources 108) with the service provider 102 or even other service provider, e.g., through analytics data. As part of this monitoring, content 404 is collected that describes which feature areas 210 of products or services with which, the user has interacted. Content 404 can include product descriptions that the user reads, product-related videos that the user watches, user reviews or user answers that the user writes, and so forth. Generally, the content 404 is consumed or provided while the user interacts with service provider 102. For example, a source 108 (e.g., user) may read various user reviews about a particular product before deciding to purchase the product. Similarly, after purchasing the product, the user may write a review about the product such that the review can be read by other users the access the service provider 102.

Functionality to monitor this user interaction is represented by a monitoring module 410. The monitoring module 410 is usable to identify particular portions of content 404, with which, the user has interacted. In some cases, monitoring module 410 identifies the particular portions content 404 are viewed by the user using an eye tracker 412. Generally, eye tracker 412 is configured to implement eye tracking techniques to identify the portions of content 404 viewed by the user by measuring either the point of gaze where the user is looking and/or the motion of an eye relative to the user's head. Assume, for example, that a user is reading content 404 containing predominantly horizontal text. The monitoring module 410 leverages eye tracker 412 to find the number of fixations on the page and the (x,y) coordinate of each fixation. Based upon the (x,y) coordinate of fixations, eye tracker 412 can determine DELTA Y and DELTA X for every two consecutive fixations, where DELTA Y=|Y2−Y1| and DELTA X=|X2−X1|. When the user is reading horizontally DELTA X will be above a threshold and DELTA Y will be smaller or close to zero. Hence, eye tracker 412 is able to identify the specific portions or regions of the content 404 that is read by the user as those regions with a high concentration of fixations.

Alternately or additionally, question answering system 120 can utilize other techniques to determine the specific portion of content read by the user, such as by using a scroll tracker 414 which monitors scrolling and/or cursor movement to determine the particular portion of content 404 that is read by the user.

Question answering system 120 provides the content 404 to text analysis module 122. Text analysis module 122 analyzes the text of content 404 to identify whether feature areas 210 are mentioned in the content 404. For each feature area 210 mentioned in content 404, text analysis module 122 generates a feature score 402. Generally, feature score 402 reflects the level of expertise of the user regarding the particular feature area 210. In one or more implementations, features score 402 is based on a feature area frequency and/or a feature area sentiment corresponding to the frequency and sentiment, respectively, of feature areas 210 occurring in content 404. Text analysis module 122 can determine the frequency of feature areas 210 occurring in content 404 using keyword frequency module 214. Then, for each feature area 210, text analysis module 122 may utilize a sentiment engine to determine the feature area sentiment of each feature area 210 mentioned in content 404.

In one or more implementations, question answering system 120 determines feature scores 402 for content 404 as the product of the feature area frequency and the feature area sentiment. For user reviews and/or user answers, this product may be further multiplied by a user-specified weight reflecting the varying importance of content that is read by the user to content that is written by the user. For example, a user that writes a user review or user answer about a particular product may receive a higher feature score 402, which reflects the fact that users who write reviews or answers may have a higher level of expertise regarding a product than users who simply read information about the product. In one or more implementations, for user answers, the product of the feature area frequency and feature area sentiment may be further multiplied by a value “N” corresponding to the number of users that have marked the answer as being helpful.

After generating a feature score 402, question answering system 120 may associate the feature score 402 with a corresponding user profile 406 of the user in the user database 408. User database 408 is searchable and/or filterable by feature score 402 which enables question answering system 120 to identify feature experts for various feature areas 210.

Identifying Feature Experts to Answer a Question about a Product

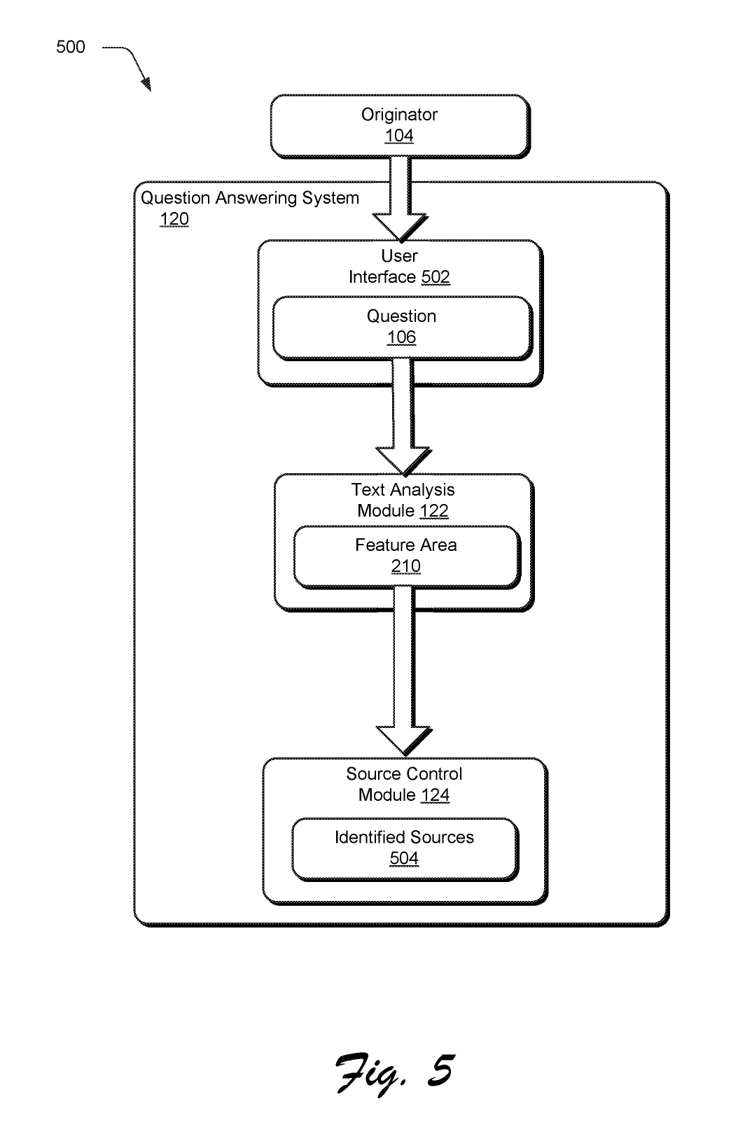

FIG. 5 depicts an example 500 in which the question answering system 120 is used to select sources to receive requests to generate answers 110 to questions 106. In this example 500, the question answering system 120 exposes a user interface 502, via which, an originator 104 may input the question 106. When a question 106 is asked about a product or service, text analysis module 122 analyzes the question to determine a feature area 210 of the question 106 based on feature areas 210 of the products or services that are mentioned in the question 106. Then, the question answering system 120 identifies one or more sources 108 to answer the question 106 (e.g., identified sources 504) based on the level of expertise of the users with regards to the feature area of the question 106 as indicated by the feature score 402.

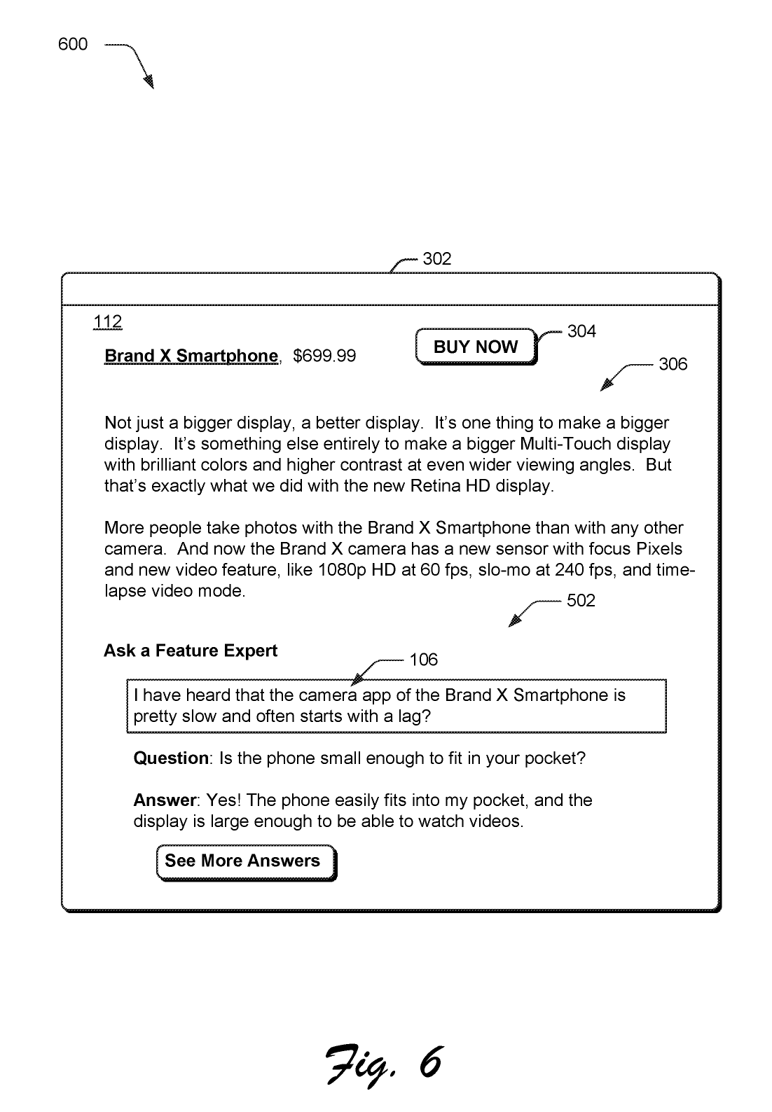

In example 500, an originator 104 asks a question 106 about a product or service by typing text of the question 106 into a user interface 502 exposed by the service provider 102. Consider, for example, FIG. 6 which illustrates an additional example 600 of a product page 302. In this example 600, a user has typed a question 106 into the user interface 502: “I have heard that the camera app of the Brand X Smartphone is pretty slow and often starts with a lag?”

When question 106 is received, question answering system 120 provides the question 106 to the text analysis module 122. The text analysis module 122 analyzes the text of question 106 to identify feature areas 210 of product that are mentioned in question 106, and utilizes keyword frequency module 204 to determine a feature area frequency corresponding to the frequency of feature areas 210 mentioned in question 106. Then, based on the feature area frequency, text analysis module 122 determines a feature area 210 of question 106. The feature area 210 classifies question 106 based on the feature areas 210 mentioned in the question. In FIG. 6, for example, text analysis module 122 may determine the feature area 210 of question 602 as being “camera of Brand X Smartphone” because the word “camera” is mentioned in question 106. Notably, text analysis module 122 can take into account related names (e.g., synonyms, hyponyms, hypernyms, and meronyms) of the feature area 210, so that even questions like “I have heard that the Brand X Smartphone is pretty slow while taking photos?” can be classified as being related to the camera of the Brand X Smartphone because of the keyword “photos” which is related to “camera”.

Based on feature area 210, question answering system 120 identifies one or more sources 108 to answer the question 106. As described throughout, sources 108 correspond to users or owners of product with a high level of expertise with regards to feature area 210 of the question 106. Question answering system 120 may identify sources 108 as users that have a high feature score 402 (e.g., above a particular threshold) corresponding to feature area 210. For example, the feature scores 122 could be configured to vary from a score of 0 (low feature expertise) to 100 (high feature expertise). In this case, sources 108 could be identified as those users with feature scores that are higher than a value of 80.

In one or more implementations, to identify sources 108, question answering system 120 sorts the user profiles 406 stored in user database 408 based on corresponding feature scores 402 for the particular feature area 210 of question 106, such that user profiles 406 with the highest feature scores 402 for the feature area 210 are placed at the top of the sorted list. Then, question answering system 120 selects the first “N” users at the top of the sorted list, where N is a user-specified value that determines how many sources 108 are to be contacted for each question 106. In one or more implementations, prior to selecting the top N users from the sorted list, users that were recently contacted to answer a different question may be removed from the sorted list. Doing so ensures that sources 108 will not be repeatedly contacted to answer questions about products.

Contacting Sources

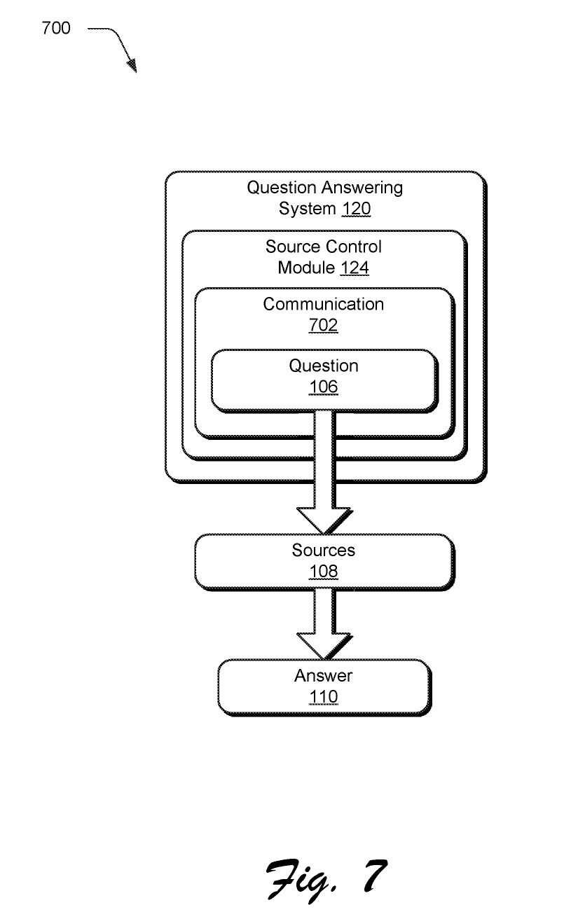

After identifying one or more sources 108, question answering system 120 communicates a request to the feature experts to answer question 106. Consider, for example, FIG. 7 which illustrates a system 700 in an example implementation in which sources 108 are contacted to answer a question.

In system 700 question answering system 120 communicates a communication 702, which includes a request to answer question 106, to sources 108. Communication 702, for example, may be a personalized email communication that is automatically generated by question answering system 120 in response to receiving question 106 and communicated to an email address associated with each respective source 108. For example, question answering system 120 may store the email address, along with other information, with the user profiles 406 in user database 408.

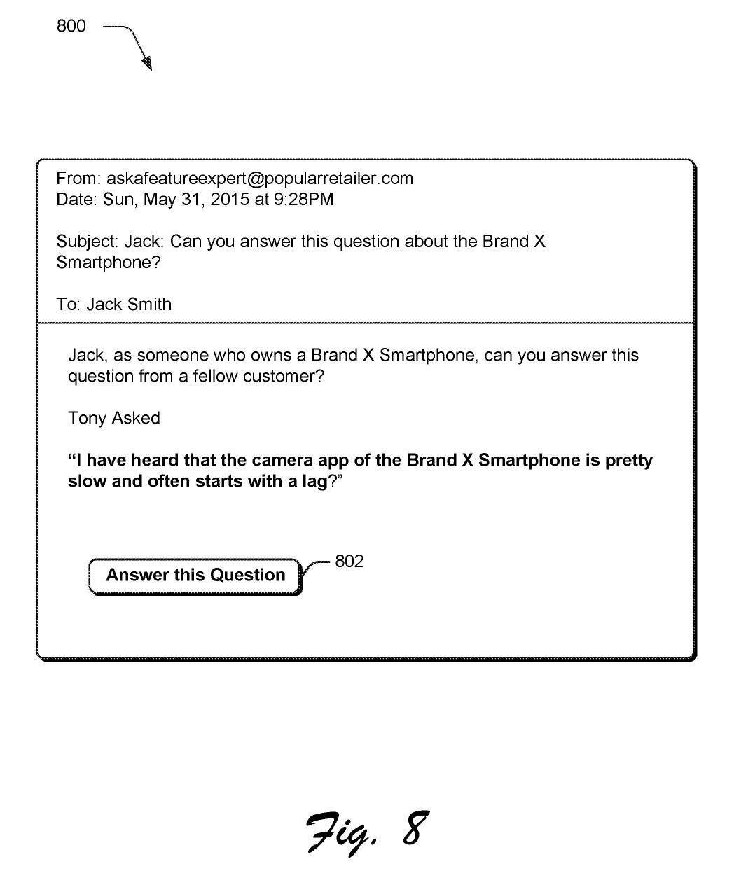

FIG. 8 illustrates an example communication 800 communicated to a feature expert. In this example, communication 800 is sent to a user, Jack Smith, with the subject “Jack: Can you answer this question about the Brand X Smartphone”. Communication 800 asks Jack if he can answer question 106: “I have heard that the camera app of the Brand X Smartphone is pretty slow and often starts with a lag?”

After communicating the communication 702, question answering system 120 receives one or more answers 110 to the question from sources 108. For example, in FIG. 8, communication 800 includes a control 802 which may be selected by Jack to answer the question 106. For example, selection of control 802 may link to a page on which Jack may provide an answer to the question. Alternately, Jack may be able to reply to communication 800 with the answer to the question. Continuing with this example, consider that Jack responds to question 106 with the following answer 110: “the picture stabilization feature of the Brand X Smartphone is known to cause lag. To try and fix the lag, tap on the little gear that's situated on screen when you open the camera application to disable picture stabilization when you don't need it”.

In some cases, after receiving answer 110, question answering system 120 causes display of question 106 and answer 110 in a user interface exposed by the service provider 102 to enable other shoppers to read the question 106 and one or more answers 110 from sources 108.

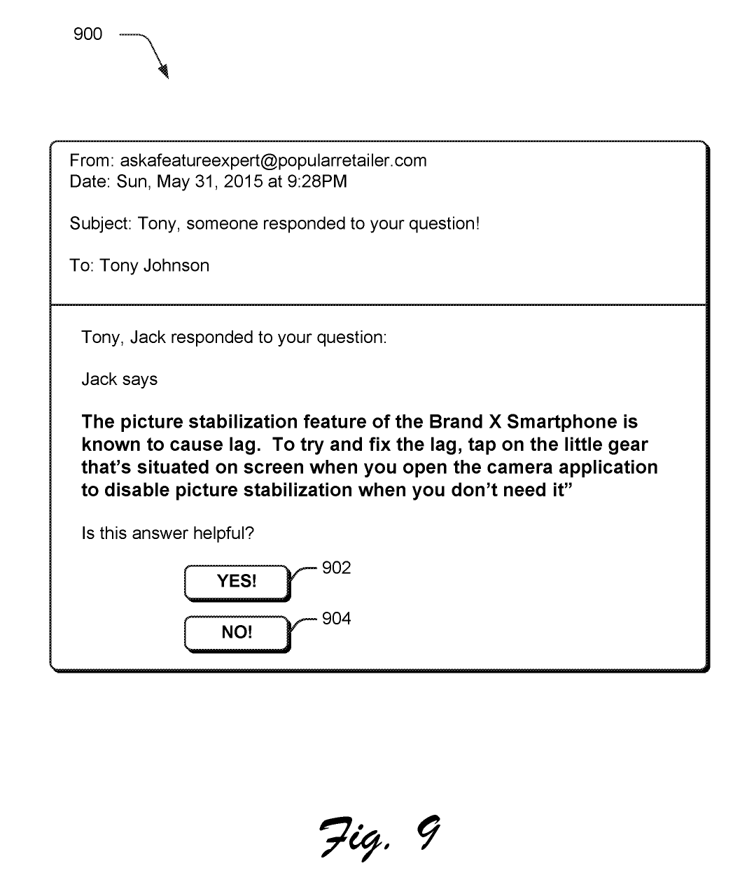

Alternately, prior to causing display of question 106 and answer 110, question answering system 120 may ask an originator 104 of the question 106 (e.g., who originally asked question 106), whether the answer 110 to question 106 is considered accurate, e.g., helpful. If the user answers that answer 110 is accurate, then the answer may be displayed in the user interface. Consider, for example, FIG. 9 which illustrates an example communication 900 that may be communicated to a user to determine whether an answer is helpful. In this example, communication 900 reproduces answer 110, and asks the user whether the answer is helpful. The user may then respond by selecting control 902 if the answer is helpful, or control 904 if the answer is not helpful.

In one or more implementations, prior to causing display of question 106 and answer 110 by the service provider 102 (e.g., exposed via a webpage), question answering system 120 may determine a sentiment of question 106. Then, if the sentiment of the question 106 is negative, the question may be modified to reflect a neutral or positive sentiment.

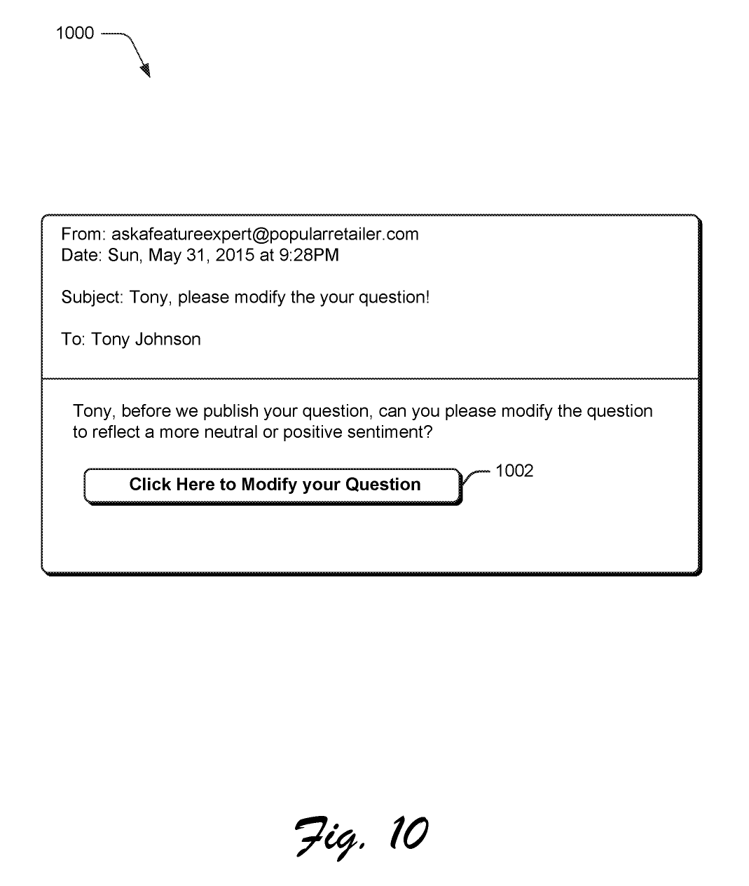

To do so, question answering system 120 may communicate a request to the originator 104 of the question 106 to modify the sentiment of question 106. Consider, for example, FIG. 10 which illustrates an example communication 1000 that may be communicated to a user to modify the sentiment of an answer. In this example, communication 1000 reproduces question 106, and asks Tony, the user that originally asked question 106, to modify the question 106 to reflect a neutral or positive sentiment. The user may then select a control 1002 to modify the sentiment of question 106. Alternately, in some cases question answering system 120 may automatically modify the sentiment of question 106.

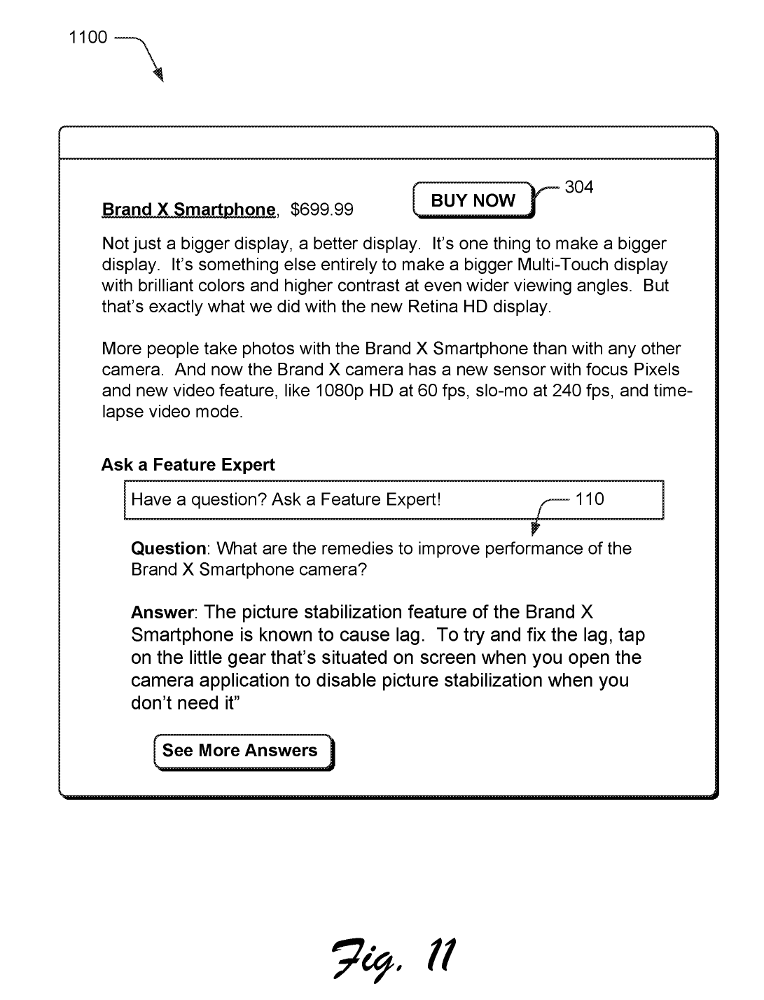

After adjusting the sentiment of question 106, question answering system 120 may cause display of the adjusted question and one or more answers in the user interface exposed by service provider 102. Consider, for example, FIG. 11 which illustrates an additional example of a product page 1100. In this example 1100, question 106 has been modified from “I have heard that the camera app of the Brand X Smartphone is pretty slow and often starts with a lag?” to “what are the remedies to improve performance of the Brand X Smartphone camera”. Notably, the modified question has the same meaning as the original question 106, but reflects a neutral sentiment towards the camera of the Brand X Smartphone.

Preemptively Determining Questions about New Products

In one or more implementations, question answering system 120 is configured to preemptively determine questions about new products or services. To do so, question answering system 120 determines whether the new product corresponds to a new version of a product or service in an existing series. For a new version of a product or service in an existing series, question answering system 120 identifies questions in a question database that were asked about a previous version of the product. For example, if mobile phone is newly-released, question answering system 120 may identify questions 128 in question database 132 asked about the previously-released mobile phone. Alternately, if there are no previous versions of the product, question answering system 120 identifies related products (e.g., competitor products) that are in the same category as the new product. For example, if a company is releasing a new tablet device, questions about an iPad may be identified. In some cases, question answering system 120 will identify and select only the questions which were marked as being helpful by users.

Then, for each identified question asked about a previous version of the product or a related product, text analysis module 122 analyzes the question 106 to determine a feature area 210 of the question 106. Based on feature area 210 of question 106, question answering system 120 identifies one or more sources 108. In this case, sources 108 correspond to users who are early adopters of the new product, or have reviewed the new product, and thus have a high level of expertise regarding the feature area 210 of the question 106. Question answering system 120 may identify sources 108 as users that have a high feature score 402 (e.g., above a particular threshold) corresponding to feature area 210. In one or more implementations, question answering system 120 sorts the user profiles 406 stored in the database 408 based on corresponding feature scores 122 for the particular feature area 210 of question 106, such that user profiles 406 with the highest feature scores 402 for the feature area 210 are placed at the top of the sorted list. Then, question answering system 120 selects the first “N” users at the top of the sorted list, where “N” is a user-specified threshold that determines how many sources 108 are contacted for each question 106. In one or more implementations, prior to selecting the top “N” users from the sorted list, users that were recently contacted to answer a different question may be removed from the sorted list.

After identifying one or more sources 108, question answering system 120 communicates a request to the identified sources 504 to answer the identified question 106 in the same manner as described above. Sources 108 may then respond with answers to the questions 128, at which point question answering system 120 populates a user interface exposed by the service provider 102 with the identified questions 128 and answers received from the feature experts. In some cases, questions 106 may include the name of the previous version of the product or the related product. Thus, question answering system 120 may be implemented to automatically replace the name of the previous version of the product (or related product) with the name of the new version of the product.

Example Procedures

The following discussion describes techniques for identifying feature experts to answer product questions. Aspects of these procedures may be implemented in hardware, firmware, or software, or a combination thereof. The procedures are shown as a set of blocks that specify operations performed by one or more devices and is not necessarily limited to the order shown for performing the operations by the respective blocks. In portions of the following discussion, reference will be made to previously referenced figures.

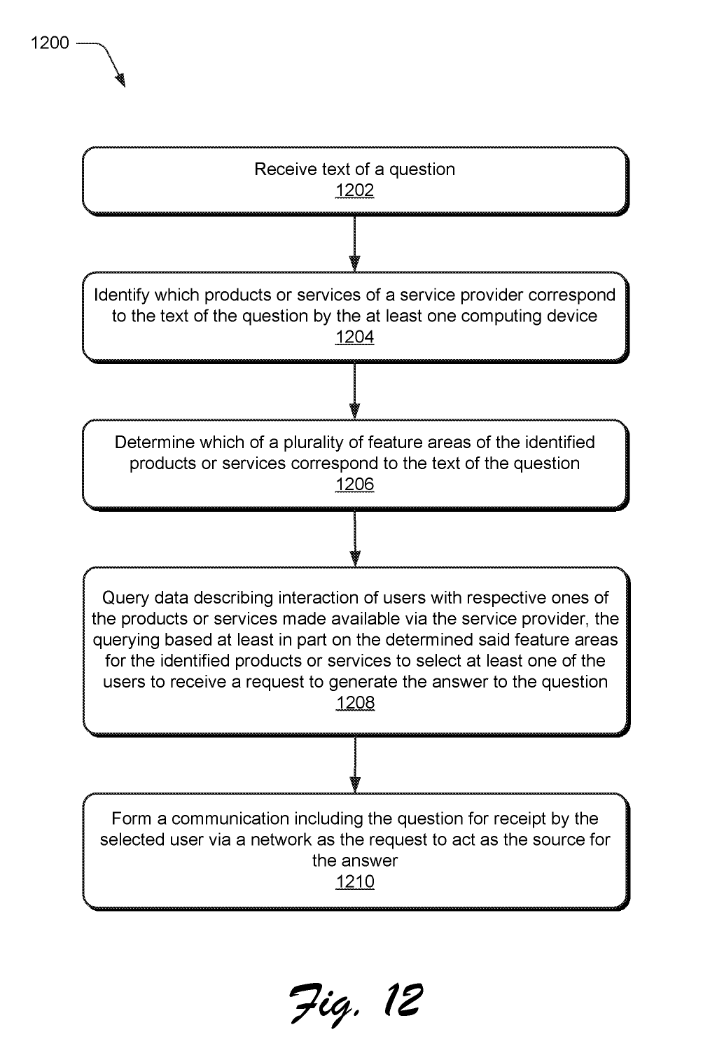

FIG. 12 depicts a procedure 1200 in an example implementation of a digital medium environment to control which source is used to generate an answer to a question about products or services made available via a service provider, the control increasing a likelihood of generation of an accurate answer to the question. At 1202, text of the question is received, such as communicated from an originator 104 to a service provider 102 via the network 112.

At 1204, identification is performed as to which of the products or services of the service provider correspond to the text of the question by the at least one computing device. A text analysis module 122 of the question answering system 120, for instance, may perform natural language processing to determine which products or services are described in the text of the question.

At 1206, a determination is made as to which of a plurality of feature areas of the identified products or services correspond to the text of the question. Continuing with the previous example, the text analysis module 122 of the question answering system 120 may also perform natural language processing to determine which feature area of products or services are described in the text of the question. For instance, the text analysis module 122 may determine that the text involves a feature area (e.g., camera) of a product (e.g., mobile phone). This result is then passed to a source control module of the service manager module 118.

At 1208, data is queried, the data describing interaction of users with respective ones of the products or services made available via the service provider. The querying is based at least in part on the determined feature areas for the identified products or services to select at least one of the users to receive a request to generate the answer to the question. The source control module 124, for instance, may employ feature scores assigned to sources 108 to determine which source 108 has exhibited expertise in relation to the identified feature area (e.g., camera) of the product or service (e.g., mobile phone). At 1210, a communication is then formed that includes the question for receipt by the selected user via a network 112 as the request to act as the source for the answer.

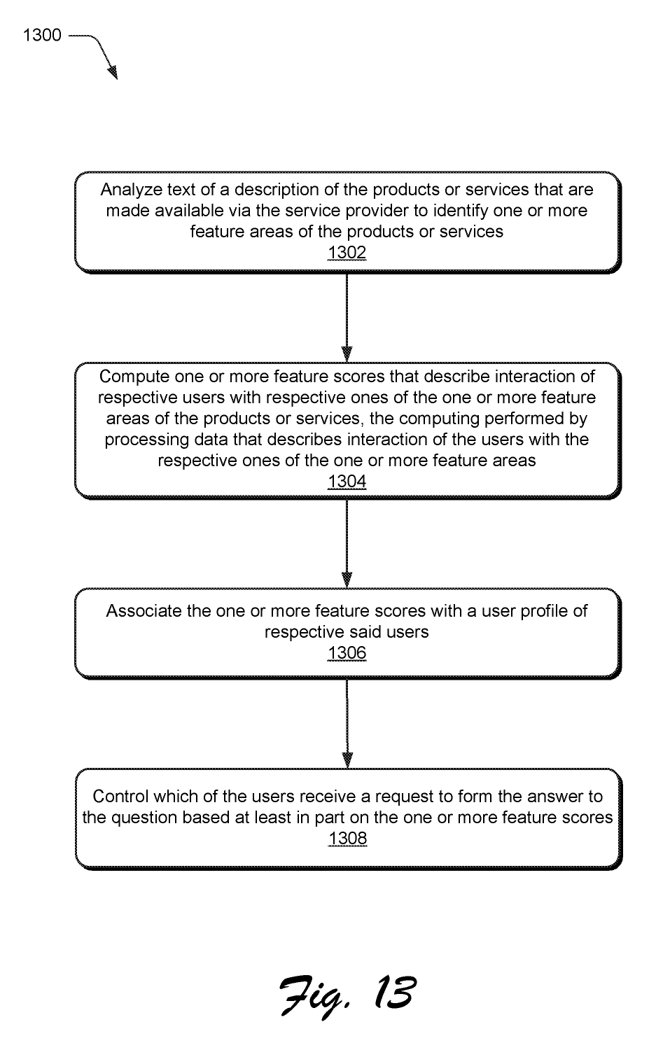

FIG. 13 depicts a procedure 1300 in an example implementation of a digital medium environment to control which of a plurality of sources is used to generate an answer to a question about products or services made available via a service provider, the control based on features scores used to identify which of the plurality of sources correspond to the question. At 1302, text of a description of the products or services that are made available via the service provider is analyzed to identify one or more feature areas of the products or services as previously described.

At 1304, one or more feature scores are computed that describe interaction of respective users with respective ones of the one or more feature areas of the products or services, the computing performed by processing data that describes interaction of the users with the respective ones of the one or more feature areas. The feature scores that serve to indicate a level of interaction exhibited by a potential source of an answer to a question and thus a likelihood of accuracy of an answer from that 108.

At 1306, the one or more feature scores are associated with a user profile of respective users. This is performed such that potential sources 108 may be efficiently located, such as through use of a lookup table.

At 1308, control is performed as to which of the users receive a request to form the answer to the question based at least in part on the one or more feature scores. This may include location of a feature area of a product of service that corresponds to the question and locating users having feature scores that indicate amounts of interaction with that feature are over a threshold amount. Other examples are also contemplated as described above.

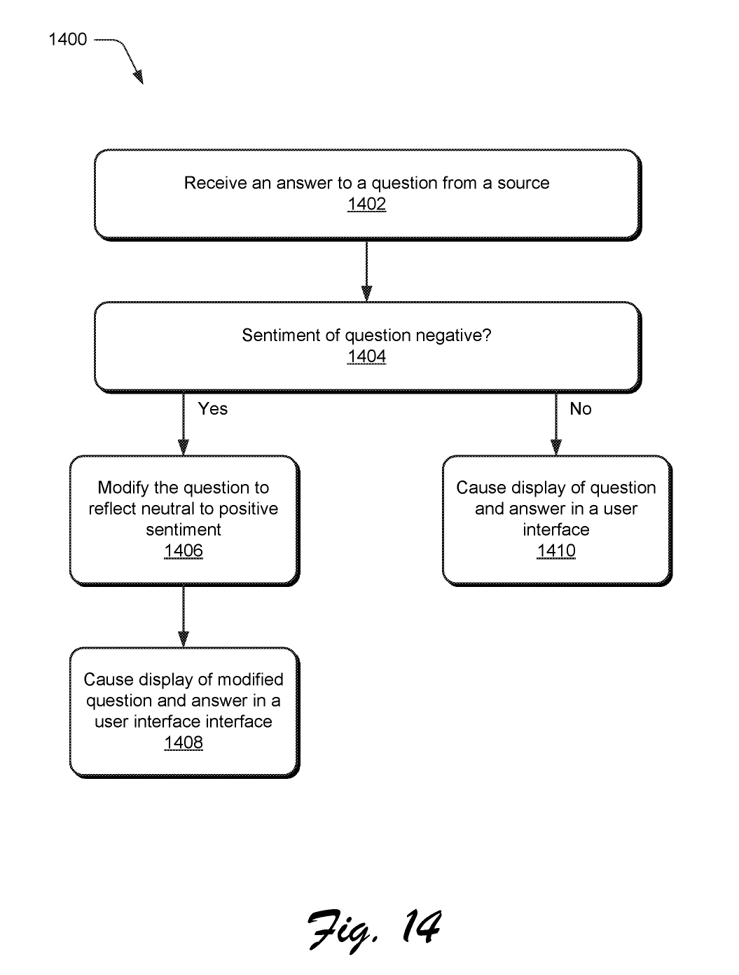

FIG. 14 illustrates a procedure 1400 in an example implementation of causing display of a question and an answer employing a user interface. At 1402, an answer 110 to a question 106 is received from a source 108. For example, question answering system 120 receives an answer 110 to a question 106 from source 108.

At 1404, it is determined whether the sentiment of the answer is negative. For example, question answering system 120 determines whether the sentiment of answer 110 is negative through natural language processing.

If the sentiment of the answer is determined to be negative, then at 1406 the question is modified to reflect a neutral to positive sentiment, and at 1408 the modified question and the answer is displayed in a use interface. For example, question answering system 120 can modify the question 106 automatically or by asking the user that originally asked the question to modify the question to reflect a neutral to positive sentiment. Then, question answering system 120 can cause display of the modified question 106 and answer 110 in a user interface.

Alternately, if the sentiment of the answer is determined to be neutral to positive, then at 1410 the question and the answer are displayed in a user interface. For example, question answering system 120 can cause display of the original question 106 and answer 110 in a user interface.

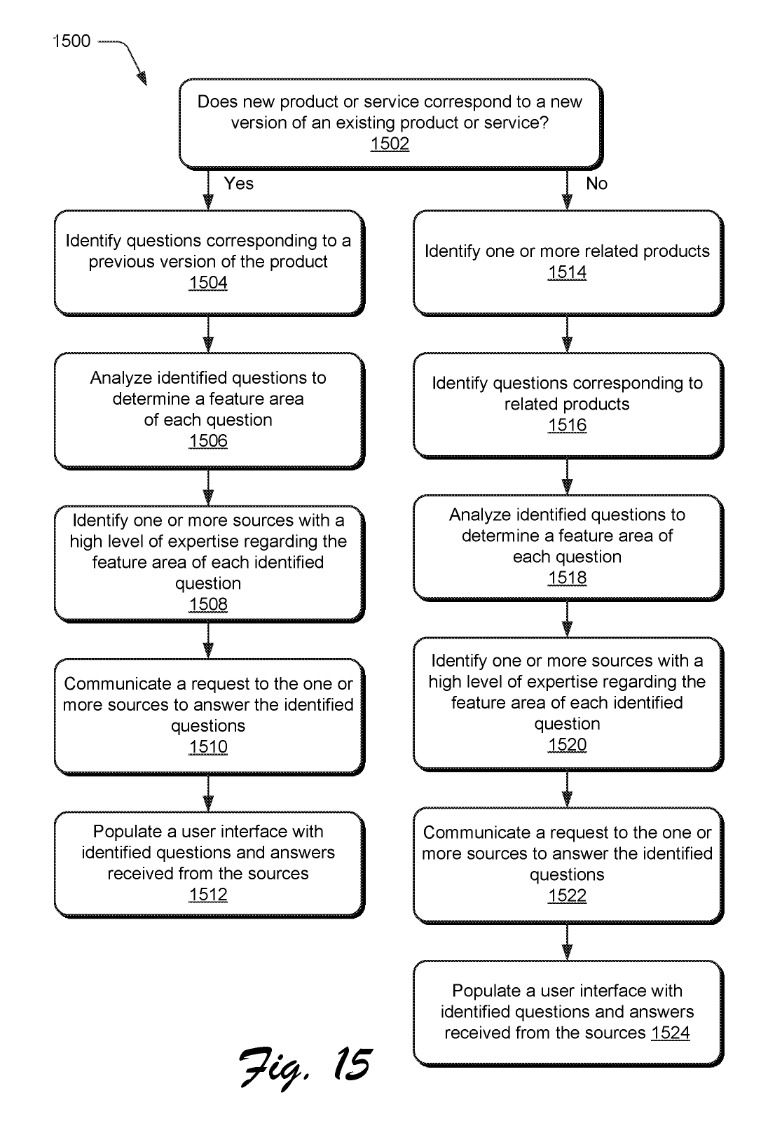

FIG. 15 illustrates a procedure 1500 in an example implementation of preemptively asking feature experts questions about a new product. At 1502, it is determined whether a new product corresponds to a new version of an existing product. If the new product corresponds to a new version of an existing product, then at 1504 questions corresponding to a previous version of the product are identified. For example, question answering system 120 identifies questions 128 in question database 132 corresponding to a previous version of the new product.

At 1506, the identified questions are analyzed to determine a feature area of each question. For example, text analysis module 122 analyzes the identified questions 106 to determine a feature area 210 of each question 106. As described above, the feature area 210 classifies question 106 based on the feature areas 210 described in text of the question.

At 1508, one or more sources 108 are identified as having a high level of expertise regarding the feature area of each question. For example, based on feature area 210 of question 106, question answering system 120 identifies one or more sources 108. Question answering system 120 may identify sources 108 as users that have a high feature score 402 (e.g., above a particular threshold) corresponding to feature area 210. In one or more implementations, question answering system 120 sorts the user profiles 406 stored in a database 408 based on corresponding feature scores 402 for the particular feature area 210 of question 106, such that user profiles 406 with the highest feature scores 402 for the feature area 210 are placed at the top of the sorted list. Then, question answering system 120 selects the first “N” users at the top of the sorted list, where “N” is a user-specified threshold that determines how many sources 108 are contacted for each question 106. In one or more implementations, prior to selecting the top “N” users from the sorted list, users that were recently contacted to answer a different question may be removed from the sorted list.

At 1510, a request is communicated to the one or more sources 108 to answer the identified questions. For example, question answering system 120 communicates a request to the sources 108 to answer the identified question 106 in the same manner as described above.

At 1512, a user interface is populated with the identified questions and answers received from the sources 108. For example, sources 108 may then respond with answers to the questions 106, at which point question answering system 120 populates the user interface with the identified questions 106 and answers 108 received from the feature experts.

Alternately, if there are no previous versions of the new product, then at 1514 one or more competitor products are identified. For example, question answering system 120 identifies related products or services (e.g., competitors) which are in the same category. In some cases, the marketer or business owner will specify the competitors of the new product.

At 1514, questions corresponding to the competitor products are identified. For example, question answering system 120 identifies questions 106 in a question database corresponding to the competitor products.

At 1518, the identified questions are analyzed to determine a feature area of each question 106. For example, text analysis module 122 analyzes the identified questions 106 to determine a feature area 210 of each question 106 as before.

At 1520, one or more sources 108 with a high level of expertise regarding the feature area of each question are identified. For example, based on feature area 210 of question 106, question answering system 120 identifies one or more sources 108. Question answering system 120 may identify sources 108 as users that have a high feature score 402 (e.g., above a particular threshold) corresponding to feature area 210. In one or more implementations, question answering system 120 sorts the user profiles 406 stored in a database 408 based on corresponding feature scores 402 for the particular feature area 210 of question 106, such that user profiles 406 with the highest feature scores 402 for the feature area 210 are placed at the top of the sorted list. Then, question answering system 120 selects the first “N” users at the top of the sorted list, where N is a user-specified threshold that determines how many sources 108 are contacted for each question 106. In one or more implementations, prior to selecting the top N users from the sorted list, users that were recently contacted to answer a different question may be removed from the sorted list.

At 1522, a request is communicated to the one or more sources to answer the identified questions. For example, question answering system 120 communicates a request to the sources 108 to answer the identified question 106 in the same manner as described above.

At 1524, a user interface is populated with the identified questions and answers received from the sources 108. For example, sources 108 may then respond with answers to the questions 128, at which point question answering system 120 populates feature the user interface with the identified questions 106 and answers 110 received from the sources 108.

Example System and Device

FIG. 16 illustrates an example system generally at 1600 that includes an example computing device 1602 that is representative of one or more computing systems and/or devices that may implement the various techniques described herein. This is illustrated through inclusion of question answering system 120, which operate as described above. The computing device 1602 may be, for example, a server of a service provider, a device associated with a client (e.g., a client device), an on-chip system, and/or any other suitable computing device or computing system.

The example computing device 1602 is illustrated includes a processing system 1604, one or more computer-readable media 1606, and one or more I/O interface 1608 that are communicatively coupled, one to another. Although not shown, the computing device 1602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1604 is representative of functionality to perform one or more operations using hardware. Accordingly, the processing system 1604 is illustrated as including hardware elements 1610 that may be configured as processors, functional blocks, and so forth. This may include implementation in hardware as an application specific integrated circuit or other logic device formed using one or more semiconductors. The hardware elements 1610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1606 is illustrated as including memory/storage 1612. The memory/storage 1612 represents memory/storage capacity associated with one or more computer-readable media. The memory/storage component 1612 may include volatile media (such as random access memory (RAM)) and/or nonvolatile media (such as read only memory (ROM), Flash memory, optical disks, magnetic disks, and so forth). The memory/storage component 1612 may include fixed media (e.g., RAM, ROM, a fixed hard drive, and so on) as well as removable media (e.g., Flash memory, a removable hard drive, an optical disc, and so forth). The computer-readable media 1606 may be configured in a variety of other ways as further described below.

Input/output interface(s) 1608 are representative of functionality to allow a user to enter commands and information to computing device 1602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1602. By way of example, and not limitation, computer-readable media may include “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 1602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1610 and computer-readable media 1606 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1610. The computing device 1602 may be configured to implement particular instructions and/or functions corresponding to the software and/or hardware modules. Accordingly, implementation of a module that is executable by the computing device 1602 as software may be achieved at least partially in hardware, e.g., through use of computer-readable storage media and/or hardware elements 1610 of the processing system 1604. The instructions and/or functions may be executable/operable by one or more articles of manufacture (for example, one or more computing devices 1602 and/or processing systems 1604) to implement techniques, modules, and examples described herein.

The techniques described herein may be supported by various configurations of the computing device 1602 and are not limited to the specific examples of the techniques described herein. This functionality may also be implemented all or in part through use of a distributed system, such as over a “cloud” 1614 via a platform 1616 as described below.

The cloud 1614 includes and/or is representative of a platform 1616 for resources 1618. The platform 1616 abstracts underlying functionality of hardware (e.g., servers) and software resources of the cloud 1614. The resources 1618 may include applications and/or data that can be utilized while computer processing is executed on servers that are remote from the computing device 1602. Resources 1618 can also include services provided over the Internet and/or through a subscriber network, such as a cellular or Wi-Fi network.

The platform 1616 may abstract resources and functions to connect the computing device 1602 with other computing devices. The platform 1616 may also serve to abstract scaling of resources to provide a corresponding level of scale to encountered demand for the resources 1618 that are implemented via the platform 1616. Accordingly, in an interconnected device implementation, implementation of functionality described herein may be distributed throughout the system 1600. For example, the functionality may be implemented in part on the computing device 1602 as well as via the platform 1616 that abstracts the functionality of the cloud 1614.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to control which source is used to generate an answer to a question about products or services made available via a service provider, the control increasing a likelihood of generation of an accurate answer to the question, a method implemented by at least one computing device comprising:
receiving text of the question by the at least one computing device;
identifying which of the products or services of the service provider correspond to the text of the question by the at least one computing device;
determining which of a plurality of feature areas of the identified products or services correspond to the text of the question by the at least one computing device;
querying data by the at least one of the computing devices, the data describing interaction of users with respective ones of the products or services made available via the service provider, the querying based at least in part on the determined said feature areas for the identified products or services to select at least one of the users to receive a request to generate the answer to the question; and
forming a communication, by the at least one computing device, including the question for receipt by the selected user via a network as the request to act as the source for the answer.

2. The method as described in claim 1, wherein the selecting is based at least on part on generating a feature score indicating a relative amount of relevance of the data that describes the interaction of respective said users has with respect to the determined said features areas for the identified products or services.

3. The method as described in claim 2, wherein the selecting includes comparing the feature scores of the users to a threshold, by the at least one computing device, and selecting the users based on the comparison.

4. The method as described in claim 2, wherein the generating of the features scores includes:
collecting the data, by the at least one computing device, describing content related to the products or services that was consumed by respective said users;
analyzing the content, by the at least one computing device, to determine a frequency or a sentiment of respective ones of the feature areas described in the content; and
generating the feature scores based on the frequency or the sentiment of the feature areas described in the content for the user.

5. The method as described in claim 1, wherein the data includes user profiles of the users.

6. The method as described in claim 1, further comprising forming a communication for communication via the network to an originator of the question, the communication including the answer received from the selected user.

7. The method as described in claim 1, wherein the determining of which of the plurality of feature areas is based at least in part on a frequency of inclusion of respective ones of the feature areas in the question.

8. The method as described of claim 1, further comprising:
determining whether a sentiment expressed by the text of the question is negative, the determining performed by the at least one computing device; and
responsive to determining, by the at least one computing device, that the sentiment of the question is negative, transforming the text of the question by the at least one computing device to reflect a neutral to positive sentiment.

9. The method as described in claim 1, further comprising:
receiving an indication by the at least one computing device from an originator of the question, the indication indicating the answer accurately corresponds to the question; and
responsive to the receiving of the indication by the at least one computing device, exposing the question and the answer via the service provider for access by at least one other user via the network.

10. In a digital medium environment to control which of a plurality of sources is used to generate an answer to a question about products or services made available via a service provider, the control based on features scores used to identify which of the plurality of sources correspond to the question, a method implemented by at least one computing device comprising:
analyzing text, by the at least one computing device, of a description of the products or services that are made available via the service provider to identify one or more feature areas of the products or services;
computing one or more feature scores that describe interaction of respective users with respective ones of the one or more feature areas of the products or services, the computing performed by processing data that describes interaction of the users with the respective ones of the one or more feature areas;
associating the one or more feature scores with a user profile of respective said users by the at least one computing device; and
controlling which of the users receive a request to form the answer to the question based at least in part on the one or more feature scores.

11. The method as described in claim 10, wherein the processing the content comprises analyzing the content to determine a frequency or a sentiment of feature areas for respective said products or services described in the content, and wherein each said feature score is based on the frequency or the sentiment regarding the feature areas of the respective said product or service described in the content.

12. The method as described in claim 9, wherein the content includes at least a portion of a description of a respective said product or service that is configured to be read by as respective said user, and wherein the feature score comprises a product of a frequency and a sentiment of feature areas described in the description of the respective said product or service.

13. The method as described in claim 12, wherein the portion of the description of the respective said product or service is identified using eye tracking.

14. The method as described in claim 12, wherein the portion of the description of the respective said product or service is identified by a scroll tracker that monitors scrolling or cursor movement.

15. The method of claim 9, wherein the content includes a user review of the product that is written by the user.

16. The method as described in claim 9, wherein the content includes a user answer to a question asked about a respective said product or service that is written by a respective said user.

17. In a digital medium environment to control which source is used to generate an answer to a question about products or services made available via a service provider, the control increasing a likelihood of generation of an accurate answer to the question, a system implemented at least partially in hardware, the system comprising:
a text analysis module implemented at least partially in hardware to:
identify which of the products or services of the service provider correspond to text of the question;
determine which of a plurality of feature areas of the identified products or services correspond to the text of the question;
a source control module implemented at least partially in hardware to:
query data describing interaction of users with respective ones of the products or services made available via the service provider, the querying based at least in part on the determined said feature areas for the identified products or services to select at least one of the users to receive a request to generate the answer to the question; and
form a communication that includes the question for receipt by the selected user via a network as the request to act as the source for the answer.

18. The system as described in claim 17, wherein the source control module performs the selecting based at least on part on a feature score indicating a relative amount of relevance of the data that describes the interaction of the respective said users with respect to the determined said features areas for the identified products or services.

19. The system as described in claim 18, wherein the source control module is configured to perform the selecting by comparing the feature scores of the users to a threshold and selecting the users based on the comparison.

20. The system as described in claim 18, wherein the source control module is configured to generate the features scores by:
collecting the data describing content related to the products or services that was consumed by respective said users;
analyzing the content to determine a frequency or a sentiment of respective ones of the feature areas described in the content; and
generating the feature scores based on the frequency or the sentiment of the feature areas described in the content for the user.
